(19) United States
(12) Patent Application Publication
(10) Pub. No.: US 2019/0193219 A1
(43) Pub. Date: Jun. 27, 2019

(54) CHANGING DEVICE AND METHOD

(71) Applicant: HOMAG GmbH, Schopfloch (DE)

(72) Inventor: Wilhelm KALMBACH, Schopfloch (DE)

(21) Appl. No.: 16/226,448

(22) Filed: Dec. 19, 2018

(30) Foreign Application Priority Data
Dec. 21, 2017 (DE) 102017130891.1

(51) Int. Cl. B23Q 1/26; B23C 9/00; B23Q 5/04

(52) U.S. Cl. CPC B23Q 1/26; B23Q 5/04; B23C 9/005

(57) ABSTRACT

The present invention provides a changing device for a multi-stage tool which has: a form-fit and/or frictional connection means that is configured to connect in a form-fit and/or frictional connection manner the changing device with a support device of a base aggregate, and a fastening means that is configured to connect the changing device with the multi-stage tool. The present invention further provides a method for changing a combination of a multi-stage tool and a changing device in an aggregate.

### TECHNICAL FIELD

The present invention relates to a changing device for a multi-stage tool according to the preamble of patent claim 1. The present invention further relates to a method according to the preamble of patent claim 9.

### PRIOR ART

The Applicant is aware of the use of multi-stage tools. Examples of multi-stage tools are, for example, multi-profile milling heads such as those used in wood processing on an aggregate, for example, in continuous operation. Such a type of multi-profile milling head can be adjusted into three discrete profile positions, with a change between the profile position, for example, occurring by applying pressure to a section of the multi-profile milling head provided for that purpose. This makes it possible, for example in woodworking, to mill on a workpiece with different radii using a single multi-profile milling head or to introduce a chamfer into the workpiece. Consequently, the overall complexity of the aggregate can be reduced.

It is disadvantageous with the multi-stage tools in the prior art that if the machining of workpieces is to take place with more stages than provided by the multi-stage tool, this is not feasible with the multi-stage tool.

### DESCRIPTION OF THE INVENTION

The present invention was therefore based on the technical problem of enabling a more flexible machining of workpieces, with the complexity of the underlying aggregate remaining low.

The invention is based on the idea that the limited machining possibilities offered by the multi-stage tool in the prior art are primarily due to the fact that only a single multi-stage tool is provided in an aggregate. Owing to installation space restrictions, it is, however, not easily possible to provide a second multi-stage tool on the aggregate since any support devices of the multi-stage tools must in this case also be provided in a dual construction.

The present invention makes use of this finding and provides a connection device for a multi-stage tool which has: a form-fit and/or frictional connection means that is configured to connect in a form-fit and/or frictional connection manner the changing device with a support device of a base aggregate, and a fastening means that is configured to connect the changing device with the multi-stage tool.

The changing device according to the invention enables the machining of workpieces with different multi-stage tools on one single aggregate, by which the technical problem formulated above is solved.

In particular, different multi-stage tools can consequently be used on an aggregate and thus a flexible machining is made possible, with the complexity of the aggregate remaining low by enabling a coupling of different multi-stage tools to one individual support device.

Preferably, the changing device additionally has a transfer device which is configured to transfer information between a base aggregate connected to the changing device and a multi-stage tool connected to the changing device.

The transfer of information in this way makes it possible to control the multi-stage tool. Consequently, this can be drive information which, for example, regulates a rotational speed of a milling head of the multi-stage tool, if the multi-stage tool is a multi-profile milling head.

This information is further preferably transferred electrically, hydraulically, pneumatically or mechanically by the transfer device.

The transfer device of the changing device is even further preferably configured to generate an adjustment of the stages of the multi-stage tool by means of the transfer of the information.

Consequently, this enables the aggregate to control the use of a specific stage of the multi-stage tool. This is advantageous with regard to the automation of the machining technology of the aggregate.

In a further preferred embodiment of the present invention, the changing device is configured to be connected with the multi-stage tool in a form-fit and/or frictional and/or material-fit connection manner.

This connection allows a solid guidance of the changing device.

The present invention further discloses an aggregate for machining workpieces which has: a changing device as shown above, a multi-stage tool, and a base aggregate which has a support device.

As regards the advantages of the method, reference is made to the advantages previously described in connection with the device.

The aggregate can preferably be configured to exchange a first combination of changing device and multi-stage tool with a second combination of changing device and multi-stage tool.

If, for example, the multi-stage tools each provide 3 stages for machining workpieces, the number of these stages is therefore doubled by the use of a second multi-stage tool. In the meantime, the unused combination of changing device and multi-stage tool can be placed and stored in a storage medium.

Accordingly, the multi-stage tool of the first combination of changing device and multi-stage tool is configured differently from the multi-stage tool of the second combination of changing device and multi-stage tool.

The method for changing a combination of a multi-stage tool and a changing device in an aggregate further preferably comprises the following steps: Accommodating the combination of a multi-stage tool and a changing device through a support device of the aggregate and creating a form-fit and/or frictional connection of the changing device with a base aggregate of the aggregate.

Even further preferably, the method shown above uses a changing device as shown above and/or an aggregate as shown above.

As regards the further advantages of the method, reference is made to the advantages previously described in connection with the device.

### BRIEF DESCRIPTION OF THE DRAWINGS

FIG. 1 is an isometric view of a preferred embodiment of the changing device according to the invention with the multi-stage tool.

FIG. 2 is an isometric view of a preferred embodiment of the changing device according to the invention with the multi-stage tool, which are arranged in a base aggregate.

FIG. 3 is an isometric view of a base aggregate from FIG. 2 in which the preferred embodiment of the changing device according to the invention is arranged without the multi-stage tool.

FIG. 4 shows a plan view of the multi-stage tool body.

### DETAILED DESCRIPTION OF PREFERRED EMBODIMENTS

In the following, preferred embodiments of the present invention will be described with reference to the accompanying drawings.

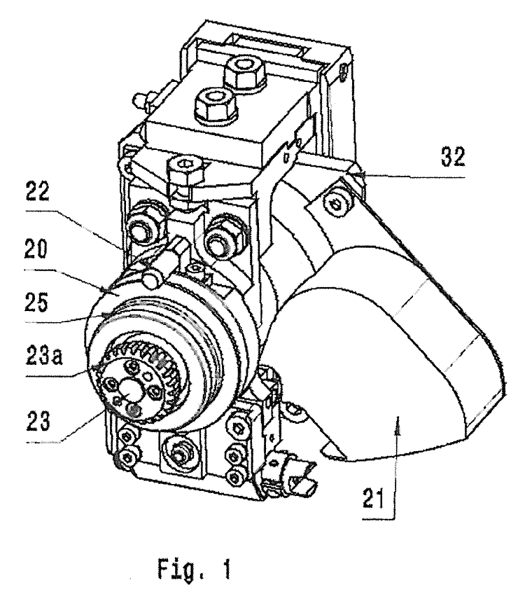

FIG. 1 shows an isometric view of a preferred embodiment of the changing device according to the invention with the multi-stage tool.

The central component to be seen here is the multi-stage tool 30 which is arranged on the changing device 20 and thereby connected with it. By applying a pressure to an adjusting means of the changing device which is not shown, the stages of the multi-stage tool 30 can be adjusted. This enables a different machining of a workpiece.

In the embodiment shown in FIG. 1, the multi-stage tool 30 is a multi-profile milling head. By applying a pressure to the adjusting means, different profiles of the multi-profile milling head can consequently be achieved. In particular, the cutting area 31 of the multi-profile milling head can be adjusted in the direction of its axis of rotation, allowing a different radius of the cutting area 31 to lie against a workpiece, since the radius of the cutting area 31 increases in the direction of its axis of rotation. The cutting area enables a machining of workpieces which, for example, are used in a base aggregate in continuous operation.

The multi-stage tool 30 is connected with the changing device 20. In the preferred embodiment shown here, this is achieved by means of a screw connection (A). Through this screw connection, a permanent, durable connection between the multi-stage tool 30 and the changing device 20 can be achieved. Other examples comprise form-fit and/or frictional and/or material-fit connections.

Driving the multi-stage tool 30 in the embodiment shown here is achieved within the changing device 20 by means of a drive transmission device which is a shaft 23 in the preferred embodiment shown here, with the shaft being driven in turn by a drive transfer device 23a of a base aggregate. In the case shown here, the drive transmission device is realized by a gear, however, hydraulic solutions and/or electric solutions are also possible.

Furthermore, the changing device 20 comprises an information transfer device 23b. Using the information transfer device 23b, information can be transferred between a base aggregate and the changing device, this applies in particular, but not exclusively, to the control of the multi-stage tool 30. Consequently, different stages of the multi-stage tool 30 can be activated or it is possible to switch between these different stages. In the preferred embodiment shown here, this is solved by a pneumatic chucking cylinder which enables to switching of the multi-stage tool 30 in the changing device 20.

The changing device 20 is further configured to make a precisely fitting connection with a base aggregate. The centering means 22 is provided for this purpose, which can be connected with a base aggregate and is a centering pin in the preferred embodiment shown here.

To connect the changing device 20 with a base aggregate, a form-fit and/or frictional connection means 25 is provided. This enables the releasable connection of the changing device 20 and a base aggregate, with the form-fit and/or frictional connection means 25, for example, being a clamping device. It is preferred that the form-fit and/or frictional connection means 25 enables a form-fit and/or frictional connection which enables an automated and/or manual separation of the milling head from the base aggregate.

When machining workpieces using the cutting area 31 of the multi-stage tool 30, abrasion of the workpiece may occur. In the case of woodworking, this abrasion is in the form of wood and/or synthetic material chips, which can be removed via a suction connection 21 on a base aggregate. It is thereby possible that the suction connection 21 causes an active suction of the abrasion, or alternatively that the active suction occurs in a connected base aggregate and suction connection 21 only directs the consequently resulting negative pressure towards the workpiece.

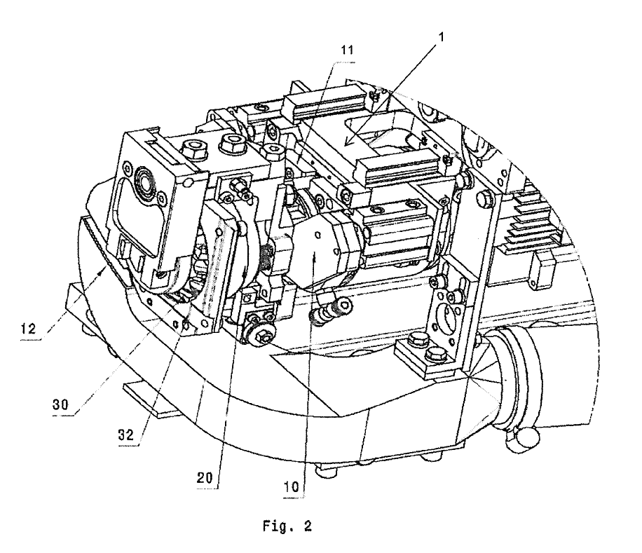

FIG. 2 is an isometric view of a preferred embodiment of the changing device according to the invention with the multi-stage tool, which are arranged in a base aggregate.

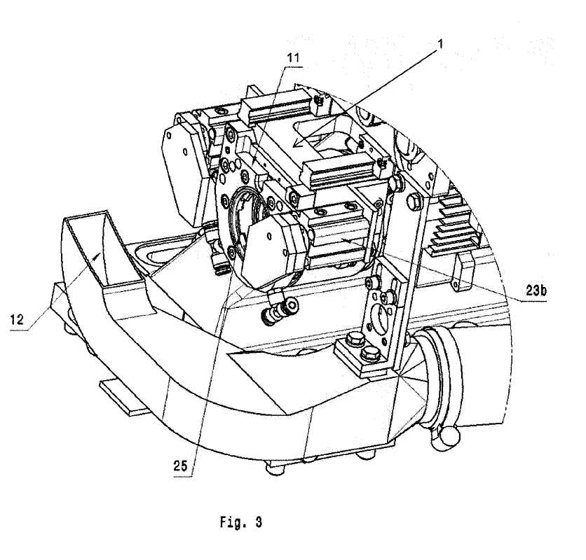

FIG. 3 is an isometric view of a base aggregate from FIG. 2 in which the preferred embodiment of the changing device according to the invention is arranged without the multi-stage tool.

These two drawings show a use of the above-described combination of changing device 20 and multi-stage tool 30 on a base aggregate 10. Together, these components form the aggregate 1.

As shown in FIG. 2 and FIG. 3, the base aggregate 10 has a support device 11. This support device 11 is configured to accommodate the combination of changing device 20 and multi-stage tool 30, i.e. to connect the base aggregate 10 with the combination of changing device 20 and multi-stage tool 30 via the support device 11.

Furthermore, the base aggregate 10 has a suction device 12. This suction device 12 is configured to to be connected to the suction connection 21 shown above in order to ensure the removal of abrasion.

In FIG. 2 and FIG. 3, the changing of a combination of a multi-stage tool 30 and a changing device 20 on the aggregate 1 is shown.

This can occur either automatically or manually, and in the preferred embodiment shown here, the automatic changing from a tool holder that is not shown is provided. To start the changing process, the support device 11 is moved to the tool holder. Subsequently, a form-fit and/or frictional connection is created between the support device 11 and the changing device 20 which, as shown above, in the preferred embodiment shown here can be achieved by means of a pneumatic chucking cylinder. The precise alignment of the combination of changing device 20 and multi-stage tool 30 with respect to the support device 11 of the base aggregate 10 is thereby achieved by means of the centering means 22. The drive transfer device 23a and the information transfer device 23b are also connected to the base aggregate in order to provide energy to the multi-stage tool 30 and to control it.

If necessary, this process can be repeated in the reversed order, by which a new combination of changing device 20 and multi-stage tool 30 can subsequently be connected with the base aggregate 10, with this new combination of changing device 20 and multi-stage tool 30 then preferably having a different multi-stage tool.

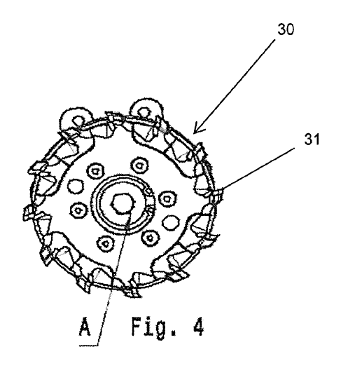

FIG. 4 is a front view of the multi-stage tool 30 as shown in a cutaway diagram in FIG. 3. In this view, it is shown that the multi-stage tool 30 is connected with a changing device 20 that is not shown here by means of the screw connection (A), in order to thereby produce a permanent, durable connection between them. Furthermore, the cutting area 31 of the multi-stage tool 30 is shown.

### LIST OF REFERENCE NUMERALS

1 Aggregate
10 Base aggregate
11 Support device
12 Suction device
20 Changing device
21 Suction connection
22 Centering means
23 Shaft
23a Drive transfer device
23b Information transfer device
24 Fastening means
25 Form-fit and/or frictional connection means
30 Multi-stage tool
31 Cutting area
32 Lateral tracing unit
A Screw connection

1. A changing device for a multi-stage tool, comprising:
a form-fit and/or frictional connection means that is configured to connect in a form-fit and/or frictional connection manner the changing device with a support device of a base aggregate; and
a fastening means that is configured to connect the changing device with the multi-stage tool.

2. The changing device according to claim 1, further comprising:
a transfer device which is configured to transfer information and/or energy between a base aggregate connected with the changing device and a multi-stage tool connected with the changing device.

3. The changing device according to claim 1, the information and/or energy being transferred electrically, hydraulically, pneumatically or mechanically by the transfer device.

4. The changing device according to claim 2, the transfer device being configured to generate an adjustment of the stages of the multi-stage tool by means of the transfer of the information.

5. The changing device according to claim 1, the changing device being configured to be connected in a form-fit and/or frictional and/or material fit connection manner to the multi-stage tool via the fastening means.

6. An aggregate for machining workpieces, comprising:
a changing device according to claim 1;
a multi-stage tool; and
a base aggregate which has a support device.

7. The aggregate according to claim 6, the aggregate being configured to exchange a first combination of changing device and multi-stage tool with a second combination of changing device and multi-stage tool.

8. The aggregate according to claim 7, the multi-stage tool of the first combination of changing device and multi-stage tool being configured differently from the multi-stage tool of the second combination of changing device and multi-stage tool.

9. A method for changing a combination of a multi-stage tool and a changing device in an aggregate, the method comprising the following steps:
accommodating the combination of a multi-stage tool and a changing device through a support device of the aggregate; and
form-fit and/or frictional connection of the changing device with a base aggregate of the aggregate.

10. The method according to claim 9, the changing device being a changing device according to claim 1.

11. The method according to claim 9, the aggregate being an aggregate according to claim 6.
